(19) United States
(12) Patent Application Publication
(10) Pub. No.: US 2014/0242920 A1
(43) Pub. Date: Aug. 28, 2014

(54) MEASUREMENT METHOD FOR ANALYSING THE PROPAGATION OF ELETROMAGNETIC NAVIGATION SIGNALS

(71) Applicant: Technische Universitat Braunschweig, Braunschweig (DE)

(72) Inventors: Robert Geise, Braunschweig (DE); Achim Enders, Braunschweig (DE)

(21) Appl. No.: 14/348,080

(22) PCT Filed: Sep. 28, 2012
(86) PCT No.: PCT/EP2012/069190

§ 371 Date: Mar. 28, 2014

(30) Foreign Application Priority Data
Sep. 30, 2011 (DE) 10 2011 054 093.8

(51) Int. Cl. H04B 17/00

(52) U.S. Cl. CPC H04B 17/009
USPC 455/67.16

(57) ABSTRACT

A measuring method for analyzing the propagation of electromagnetic navigation signals, wherein at least one representative transmitting unit, having a chronological signal feed scheme unambiguously assigned to the navigation signal, is assigned to each of the navigation signals.

The representative transmitting units are at least intermittently operated offset in time. A characteristic transmission-free leader pause duration and transmission-free trailer pause duration or a characteristic transmitting duration is assigned to each representative transmitting unit.

An analysis unit is coupled to a receiving unit and a time-dependent amplitude detection is carried out, wherein the time curve of the received amplitude values is analyzed by the analysis unit to assign the representative transmitting unit to timeslots of the received amplitude values. The pause durations and/or the transmitting durations in the time curve are analyzed and the origin transmitting units of the signal are ascertained on the basis of these items of information.

The invention relates to a measurement method for studying the multipath propagation and scattering of electromagnetic waves.

With increasing relevance and more and more intensive use of electromagnetic signal transmission, in the event of simultaneous increase of the complexity of systems, the analysis of the propagation and interaction of electromagnetic signals in the systems is becoming more and more important. In particular for navigation systems in air traffic, the multipath propagation, i.e., the change of a navigation signal by reflections or scattering on objects on a path between transmitter and receiver, is of safety-relevant and also economic significance. The safety-relevant requirement that the changes of a navigation signal cannot exceed internationally applicable tolerance limits, automatically places corresponding demands on the handling of the air traffic, which always have a restrictive effect with regard to economic aspects such as airport capacity.

The meteorological characterization of time-variant (multipath) propagation channels is fundamentally an accepted concept, in particular in the field of the mobile wireless or communication sectors. In particular so-called “channel sounding” is known for this purpose in the prior art. The approach in this case is to measure the reaction of a propagation channel to a given signal form, typically a pulse (the reaction is then referred to as a pulse response), in the shortest possible time intervals, in which the transmission channel chronologically changes. An overview of structures and functionalities of such channel sounders can be found in “Wireless Communications”, 2nd ed., Andreas F. Molisch, ISBN 978-0-470-74186-3, Wiley and Sons Ltd., pages 145-164.

Refining concepts provide a spatial differential observation of the pulse responses, which is also referred to as vectorial channel sounding, as disclosed, for example, in DE 19741991C1.

The patent specification DE 102004041121B3 is also concerned with a spatially resolved, time-variant observation of channels, which are subject to multipath propagation.

However, the concepts are not readily transferable reasonably to the study of navigation signals, since the characterization of propagation channels using typical variables from telecommunications such as a maximum runtime or a delay spread, or the knowledge of an entire pulse response, is often not necessary.

Fundamentally, in the case of such multipath propagations of navigation signals, the influences of static scattering objects, for example, airport buildings, are already taken into consideration in the planning of an airport and can also partially be minimized by an intelligent analysis of the signals. On the other hand, the influence of movable objects, for example, the airplanes on the landing field of an airport, can be more difficult to analyze as a result of the variety of arrangements and configurations. In particular the increasing size of passenger airplanes represents a critical reflection potential with influence on the integrity of the landing course emitted by the instrument landing system (ILS).

To be able to plan such ILS protection zones to avoid such reflections with respect to safety and cost-effectiveness, the knowledge of scattering behavior of corresponding interfering objects is indispensable, however.

Complex systems are not available as desired for the planning and analysis, however, in particular for the measuring. The desired measurements can hardly be represented cost-effectively at a real airport.

However, the exact scattering behavior of larger and possibly moving objects cannot always be calculated by simulation technology under nonideal boundary conditions, for example, the one level incident wave, as also in the above-mentioned case of the instrument landing system. Corresponding measurements at real airports also prove to be extraordinarily difficult, on the one hand, because of the restricted availability during regular flight operation and, on the other hand, because the very complex airport environment in the totality thereof of the reflection objects can hardly be detected reproducibly and therefore cannot be restricted reproducibly to a single object to be studied.

Not least, required measurements cannot be represented cost-effectively on a real airport in such a large parameter space (position and alignment of various airplanes and possibly movements).

An effective alternative to simulations and measurements on real airports is represented by electromagnetic scaling of such a reflection environment. Therefore, measurements are performed in scaled environments. According to the physical fundamental principle of scalability for dispersion-free materials, wherein the scattering behavior of objects is only dependent on the ratio of the object dimensions and the wavelength, the actual reflection scenario to be studied can be transferred into a typically shrunken environment upon corresponding increase of the frequency.

Such a shrunken environment not only has the advantage of unrestricted availability, it additionally also permits the reduction of the complex airport environment only to the actual scattering object to be studied, for example, an airplane in taxiing traffic. In the dissertation of the inventor (“Skalierte Messungen zu bistatischen Radarquerschnitten and Landekursverfälschungen des ILS [Scaled Measurements of Bistatic Radar Cross-Sections and Landing Course Corruptions of the ILS]”, Robert Geise, ISBN 978-3869555706), the implementation of a scaled measuring environment for the instrument landing system having a scaling factor of 1:144 is presented, i.e., instead of the original frequency of the landing course signal around 110 MHz, a scaled ILS is operated at 15.9 GHz.

Scaled measuring environments not only have the advantage that they are available at any time and can be operated with cost-effectively low expenditure, which is therefore acceptable. They also permit the simulation of situations which in reality cannot be represented at all, or can only be represented with high expenditure or with high risk, for example, possible expansion or renovation projects at airports or emergency landing scenarios from nonideal approach directions.

While the scaling of the reflection objects is a solely mechanical shrinkage to scale, the simulation of navigation sources with corresponding navigation signals at scaled higher frequencies is a technically substantially more demanding task, which may fundamentally be divided into two essential components. On the one hand, it is necessary to simulate the emission characteristic of the original navigation source, at least in the relevant emission angle range, as precisely as possible using the scaled antenna, since the reflection properties of a scattering objects are automatically also dependent on how it is irradiated. Such diagram shaping of a scaled carrier signal in a scaled measuring environment can already be simulated well, the inventor has already filed a further application in this regard.

On the other hand, it is also decisive to connect the corresponding navigation information to precisely this emission characteristic in the form of an item of differential spatial or location information. It is firstly obvious in this case to use the same modulation method as in the source to be reproduced. Correspondingly, the prior art (“Skalierte Messungen zu bistatischen Radarquerschnitten and Landekursverfälschungen des ILS”, Robert Geise, ISBN 978-3869555706) uses the frequency information for the receiving-side differentiation between the signals and the assignment to specific transmitting units.

However, this methodology becomes very technically complex due to the significantly higher frequencies, on the one hand. On the other hand, it also places corresponding demands on the receiving unit within the scaled measuring construction, which can certainly have a restrictive effect with regard to the actual measurement task, for example, in the form of longer measuring times, as will be explained hereafter on the basis of the modeling of the ILS. In any case, a correspondingly small resolution bandwidth is necessary in the known methods, to be able to differentiate both frequency components of the different transmitting units and therefore to obtain the actual signal, although actually only two discrete amplitude values would be necessary. The detection of an entire spectrum at correspondingly high resolution substantially limits the measuring speed.

The object of the invention is therefore to make real sources in simulated systems analyzable more easily and with lower expenditure for measuring devices, so that the propagation information is retained and, on the other hand, movement effects and also Doppler effects can be measured with higher chronological resolution.

This object is achieved by methods having the features of patent claim 1 or patent claim 2.

The measuring method according to the invention allows the analysis of the propagation of electromagnetic navigation signals of greatly varying navigation systems.

It is fundamental for the invention to understand these navigation signals in general as a superposition of multiple components of individually oriented items of spatial information, which can possibly also change chronologically. This mode of observation is simple to reproduce in the case of the primary radar, for example, since respective main emission directions of the rotating radar antenna are assigned to varying points in time. This mode of observation becomes more abstract in the case of static navigation systems, for example, the instrument landing system, since the individually oriented items of spatial information, as components of the navigation signal, are not based on a movement of the antenna, but rather on a more complex feed of elements of a group antenna. However, this spatial modulation of a more complex navigation signal which results therefrom is also to be attributed to the fact that various antennas are excited differently at variable points in time. As a further example, the microwave landing system can also be expressed as an electronically pivotable group antenna (phased array). The chronologically changing main emission direction is set by a corresponding chronologically varying phase offset of individual beams. These predefined, optionally discretized main emission directions can also be understood in this case as multiple components of the navigation signals which are activated chronologically differently. The functionality of the rotating radio beacon may also be interpreted in this manner.

For the implementation of an arbitrary navigation system in a measuring environment, according to the invention, at least one representative transmitting unit is assigned to each such above-mentioned navigation signal component. These representative transmitting units are intermittently operated offset in time, wherein every representative transmitting unit, according to one aspect of the invention, is assigned at least one characteristic transmission-free leader pause duration and/or transmission-free trailer pause duration. The navigation signals, which can be differentiated in a navigation system by location or spatial direction and frequency, are thus assigned representative transmitting units, which convert, i.e., “reproduce”, these navigation signal components into a scenario having substantially equal frequency, but different signal sequence. According to a second aspect of the invention, the representative transmitting units are operated at least intermittently offset in time, wherein every representative transmitting unit, according to one aspect of the invention, is assigned at least one characteristic transmitting duration, i.e., a duration having active emission.

It is essential that the differentiation of the navigation signal components reproduced by a transmitting unit is achieved by a differentiability of the chronological feed scheme. Both the time between the active transmitting phases (i.e., the pause time) and also the duration of the active transmitting phases itself can be used for the characterization and as an identification feature.

Between the operating phases of the representative transmitting units, accordingly either characteristic transmission-free leader pause durations and/or transmission-free trailer pause durations are maintained and/or the units are operated using characteristic transmitting duration.

The term “characteristic pause duration” in this context means that an assignment of the representative transmitting units and the reproduced navigation signal components thereof to the pause duration is possible. The respective representative transmitting unit and the reproduced signal (a real navigation component) are identifiable on the basis of a pause duration or a sequence of pause durations, interrupted by the transmitting phases of the transmitting units. It is clear that in the event of successive signals, the trailer pause duration, i.e., the transmission-free time after the active phase of a transmitting unit, forms the leader pause duration of a chronologically following transmitting unit.

On the other hand, the term “characteristic transmitting duration” means that an assignment of the representative transmitting unit to its individual transmitting duration is possible. On the basis of a transmitting duration or a sequence of transmitting durations, interrupted by the pause phases of the transmitting units, the respective representative transmitting unit and the associated navigation signal are identifiable.

According to the invention, an analysis unit is coupled to a receiving unit and a time-dependent amplitude detection is carried out, which is matching with the transmitting or receiving frequency, on the one hand, and allows an identification of the individual chronological feed schemes of the representative transmitting units, on the other hand.

Such an amplitude detection can be performed, for example, using a spectrum analyzer on or around the receiving frequency, i.e., in the zero span mode, since according to the invention no frequency information is necessary for assignment of the representative transmitting units. The amplitude detection can also be performed using an oscilloscope while maintaining the minimum sampling rate to the receiving frequency.

As described above, the assignment of signals to be studied (navigation signal components) to a respective representative transmitting unit does not have to be performed 1:1 in this context. Rather, a representative transmitting unit as a unit according to the object can certainly reproduce various navigation signal components, wherein, however, the representative transmitting unit is then also fed differently with different chronological feed schemes, i.e., pause durations or transmitting durations, depending on the reproduced signal. This is true in particular if signals having identical origin location but different signal characteristic (for example, frequency) are to be reproduced.

According to the invention, the assignment of navigation signal components to the chronological characteristic is unambiguous, however, a representative transmitting unit can be fed with different chronological characteristics. The emission of various signal components by a single transmitting unit can be performed, for example, in that a waveguide antenna is fed in different ways, for example, from various sides, but this is performed with different chronological characteristic, i.e., characteristic pause duration or transmitting duration. When fed from a first side, a first navigation signal component is reproduced, when fed from a second side and with another pause or transmitting duration, a second navigation signal component is reproduced.

The time curve of the received amplitude values is analyzed by the analysis unit to assign the representative transmitting unit to time slots of the received amplitude values, in that the pause durations or transmitting durations in the time curve of the amplitude values are assigned to the leader pause durations and/or trailer pause durations of the representative transmitting units or the transmitting durations thereof.

An essential advantage of the invention in relation to above-mentioned fundamental concepts of channel sounding is that no synchronization (for example, via cable or GPS) or correlation, which can possibly be very technically complex, is necessary between transmitting unit and receiving unit. Synchronization means in this case that the receiving unit already requires for its proper receiving operation the precise information about the point in time at which signals were transmitted, possibly from various transmitting units. I.e., the receiving unit must be triggered precisely at the point in time at which a broadband signal also actually arrives at the receiver, so that the receiving-side limited memory capacity is also used for the actual signal to be measured.

Precisely this synchronization is not required according to the invention, since during the regular measuring operation, continuous amplitude detection is performed in any case and the assignment to representative transmitting units can be performed a posteriori.

This is because in contrast to transmission channels from classical telecommunications, which must necessarily be characterized as very broadband because of higher transmission rates, the transmission channels of navigation systems can be considered to be rather narrowband, which significantly reduces the memory capacity required on the receiving side and therefore also the demand for a synchronization.

Therefore, it is also not necessary on the transmitting side to generate a special broadband signal form such as a short pulse, since according to the invention the use of CW signals for the studying, which propagate and are possibly corrupted like navigation signals, is sufficient. The invention permits the propagation and also possible corruptions of navigation signals of various or arbitrary navigation systems to be studied on a technically simpler level.

The concept according to the invention can be applied to arbitrary navigation systems.

To allow rapid chronological detection and therefore the time-variant multipath propagation of a navigation signal, it is proposed according to the invention that signals be detected in a time-resolved manner and with high bandwidth. A differentiability of real navigation signal components can be in the frequency range or in another feature. These characteristic features of the navigation signal components are transferred according to the invention into a differentiability in the time range, so that the received signals are to be received with greater bandwidth, for example, in the zero span operation of a spectrum analyzer, and therefore make possible significantly higher time resolution. Alternatively, depending on the measuring frequency, conversion or mixing down using separate means and subsequent analysis, for example, by an oscilloscope, is also possible.

According to the invention, the transmitters are fed time-offset and without chronological overlap in a time scheme, so that always only one representative transmitting unit or antenna is active. The item of information on which antenna is active is allowed by the analysis in the time range, in that characteristic pause durations or transmitting durations between the signals of the antenna are maintained. In this manner, the baseband can be analyzed with a significantly higher time resolution. Due to the chronological sequence, a representative transmitting arrangement or transmitting antenna can be identified with its corresponding spatial alignment and therefore its component of an item of differential location information, whereby then, for example, the item of navigation information or a possible corruption may be determined.

It is essential for the invention that different signals as a component of an item of navigation information are not identified on the basis of their frequency, but rather on the basis of the transmission-free and signal-free leader pause duration or trailer pause duration or also on the basis of the transmitting duration of an antenna, however.

The assignment of parts of a chronological signal curve to different representative transmitting units (possibly having various spatial alignments) is possible in this manner, although all representative transmitting units can be operated at the same frequency, so that measurement can be formed using a corresponding broadband filter, i.e., higher sampling rate. It is not absolutely necessary in this context for the transmitters to transmit with identical frequency, however, if they do so, a differentiation is possible on the basis of the pause duration between the signals or on the basis of the transmitting duration (signal duration).

The method according to the invention is preferably used for scaling the items of landing course information of instrument landing systems. The invention is explained hereafter proceeding from the prior art with respect to the scaling of the ILS.

In the landing course of the instrument landing system, the item of differential location or navigation information, the lateral deviation from the middle of the runway, is generated by the spatial amplitude modulation (AM) of a group antenna. The analysis of the side bands generated by the AM in the received frequency spectrum is the measure in this case for the deviations from the center of the runway (difference in depth of modulation, DDM). An essential abstraction step in the scaled simulation of the ILS, which was also completed in the above-mentioned publication, is that only the emission characteristic of these two side bands is modeled. Technically complex modulation of a carrier signal is replaced in this case by two individual antennas which are spatially aligned accordingly, and which represent the side bands and transmit with a slight frequency offset, to be able to be differentiated. In the case of the scaled simulation of an ILS, these are two antennas which emit slightly offset mirror-symmetrically, on the left and right of the middle of the runway. If this slight frequency offset is reproduced in the scaled environment (for example, 15.9 GHz and 15.9 GHz+1.5 kHz), at a specific receiving location, a spectrum of signals is always to be analyzed and stored to differentiate the transmitting antennas. In the above-mentioned example, a spectrum which is 3 kHz wide is recorded to take into consideration possible frequency drift. A correspondingly small resolution bandwidth of 300 Hz is necessary in this case to be able to differentiate both frequency components and therefore obtain the actual scaled navigation signal. However, only two discrete amplitude values are fundamentally necessary for this purpose. The detection of an entire spectrum at correspondingly high resolution substantially limits the measuring speed, however.

In a preferred embodiment of the invention, the propagation of the electromagnetic navigation signals is analyzed with the aid of the representative transmitting units in scaled measuring environments. The representative transmitting units assigned to the navigation signals are still operated using scaled, higher frequencies, however, the reception is performed with higher chronological resolution and greater bandwidth. The differentiation into a resolved spectrum is given up and instead the amplitudes detected in the bandwidth range are analyzed. However, since frequency assignment of the signal is no longer possible in this amplitude signal, according to the invention, the items of identification information are coded in the pause times.

To analyze the signals, i.e., in the analysis unit, firstly a frequency conversion can be performed as a function of the frequency of the received signals. For example, the signals can be mixed down with the aid of a mixer to a significantly lower intermediate frequency, to be analyzable by means of conventional analog-digital technology or an oscilloscope in the time range. Alternatively, a spectrum analyzer can be used, in which a conversion is provided inside the device. The first variant of the analysis unit could allow a higher chronological resolution, since the intermediate frequency filter bandwidth of commercially available spectrum analyzers is at several tens of megahertz.

In the scope of the invention, it is additionally fundamentally possible to also design the signal duration differently, to offer a further identification possibility of the transmitting antennas. In addition, the pauses can be selected as a function of the number of the antennas such that the origin of the signal can already be determined on the basis of a single pause before an amplitude signal. However, the analysis of multiple pauses can also be necessary in order to assign the signals.

As a function of the detection speed, the signal run time in the case of multipath propagation paths, and the frequencies, the differences of the pause times are to be selected such that a significant differentiation is possible in any case. In the case of typical scaled environments, for example, it can be presumed that in the case of multipath propagation of 100 m, the runtime and change is less than 1 μs. Pause times between the signals could be between several tens of microseconds and 1 ms here, for example, wherein the pause times themselves differ by 10% to 100%, for example.

The representative transmitting units can be operated at identical frequency or at different frequencies, which are located in the detection bandwidth of the receiving unit, however. In the case of different frequencies, in addition to the analysis according to the invention, a parallel or also time-offset analysis with detection of a frequency spectrum can also be performed. In this case, the signals of the representative transmitting units are to be differentiated both in the frequency space and also by their feed scheme or time scheme. In the case of emission at the same frequency, the spectral bandwidth to be detected can be reduced and an improved signal-to-noise ratio can regularly be achieved.

In a preferred refinement of the invention, multiple transmitters are arranged along an arbitrary emission front and these transmitters are activated to transmit in a time-offset and cyclic manner, wherein a characteristic transmission-free leader pause duration and/or characteristic transmission-free trailer pause duration is assigned to every transmitter.

For example, using this system, a movement of a single transmitting unit occurring in the real system, for example, the rotation of a radar antenna, is reproducible. The transmitters are then arranged along a circular line and activated in a circulating manner, with respective characteristic pause duration before and after activation. In this manner, a scaled measurement of moving transmitting units is possible. In this case, the movement of a single antenna in the real system is thus simulated by a plurality of antennas having identical transmitting frequency in the scaled system, wherein the various rotational positions are identifiable by their pause times. The circular arrangements of the individual antennas of the rotating radio beacon at an airport can also be simulated using this invention. It is also possible to arrange representative transmitting units along a trajectory of a moving object, to simulate a navigation system which is located on an airplane in movement, for example.

In the scaled measuring environment, it is reproducible at any time, by the time curve of the antenna feed, at which measuring point in time a single antenna of the scaled navigation system was active. Correspondingly, the scaled navigation signal, which is possibly corrupted by multipath propagation, can be transferred into the real simulated representation of the actual navigation signal and analyzed. Since a chronologically rapid analysis of the navigation signals is made possible by this invention, it is then also possible to study correspondingly rapid changes of the boundary conditions of multipath propagations, for example, rotating windmills or moving airplanes.

Using a similar system it is also possible, for example, to simulate a sector antenna from mobile wireless. An outgoing signal of a sector of the antenna would be identifiable here by defined and recognizable pauses before and after the application of the signal to the corresponding antenna.

An identification of the representative transmitting antenna on the basis of a single pause duration is possible. In a refinement of the invention, respectively multiple pause durations which are separated by received amplitude values are analyzed to perform and validate the signal assignment to the transmitting antennas. For example, two or more sequential pause durations, which are separated by the reception of signals using the receiving unit, as a pause sequence, permit an unambiguous identification of the interposed signal. However, further pause durations are also analyzable, wherein the reliability of the recognition is increased further. This refinement of the invention suggests itself in particular in environments having interference or upon the specification of slight differences in the pause durations.

In a preferred embodiment of the method, the representative transmitter units emit signals in the gigahertz range. In this frequency range, the advantages of the method according to the invention play out particularly strongly, since here the analysis in the case of smaller frequency differences particularly restricts the chronological resolution possibilities. The use within scaled measuring environments for, for example, the above-mentioned navigation systems is considered to be a preferred embodiment of the method. This is because due to the scaling, i.e., the shortening of the propagation paths, a sharp contrast ratio first results between the switching or pause times of the individual antennas and the signal runtimes during the multipath propagations under chronologically variable boundary conditions, which are to be studied.

Fundamentally, however, this method is also executable in other, non-scaled measuring environments, in which an assignment of a received signal to a transmitting unit or a navigation component is necessary or reasonable. This is conceivable in principle in arbitrary environments, in which the finding of reflection or scattering centers can be performed by assigning propagation paths of individual transmitting units having preferred main emission directions.

Since studying in the frequency range is no longer necessary for this assignment, it is according to the invention and favorable for a measured value detection with high chronological resolution, to mix down the carrier frequency to a lower intermediate frequency, whose time curve can be measured with higher intermediate frequency bandwidth, for example, in the zero span mode using a spectrum analyzer. The chronological amplitude curves of this intermediate frequency, which can be differentiated from one another by corresponding pause times, then correspond to the respective modulation of the carrier frequency, as results due to the multipath propagation, as a function of various spatial directions, which are predefined by the respective main emission direction of the active or assigned antenna. A constant offset between two such amplitude curves would mean, for example, that a reflection on a static object occurs in a propagation direction or main emission direction.

However, this difference can also vary within multiple measuring cycles, for example, due to the movement of just such a reflection object. Chronological variations are then also conceivable, for example, if the receiver moves, i.e., changes its spatial location in relation to the reflection object, wherein the reflection object also reflects or scatters with different strengths in various spatial directions.

It is particularly advantageous if the active transmitting duration of the transmitter is equal with identical frequency and a differentiation only occurs on the basis of the pause times.

A variation of the individual transmitting durations is fundamentally also possible, however, a critical check is then to be carried out during the later analysis as to whether the differing pulse duration in the amplitude detection is to be attributed to possible interaction effects of the electromagnetic wave with a measuring environment or to a differing emission duration of the antenna. If each of the antennas is operated with identical transmitting duration at all times, the analysis can be restricted solely to the pauses and effects by interaction of the radiation in the system are unambiguously identifiable.

The activation of the transmitting antenna and the setting of the pause duration or transmitting duration can be set both using HF switches, optionally in the form of a matrix, and also using delay lines. Depending on which pause durations are desired, in particular short pause durations can be implemented by means of delay lines and greater pause durations can be implemented using corresponding switch units.

The invention will be explained in greater detail on the basis of the following figures.

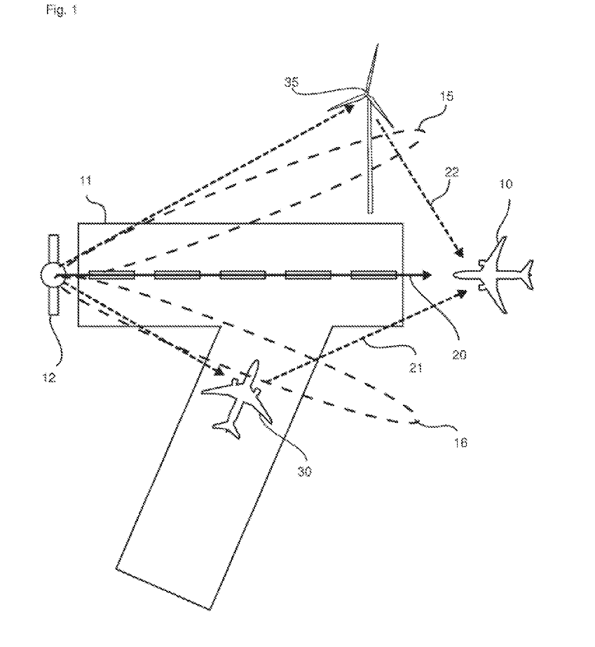

FIG. 1 shows an exemplary measuring environment for the application of the invention;

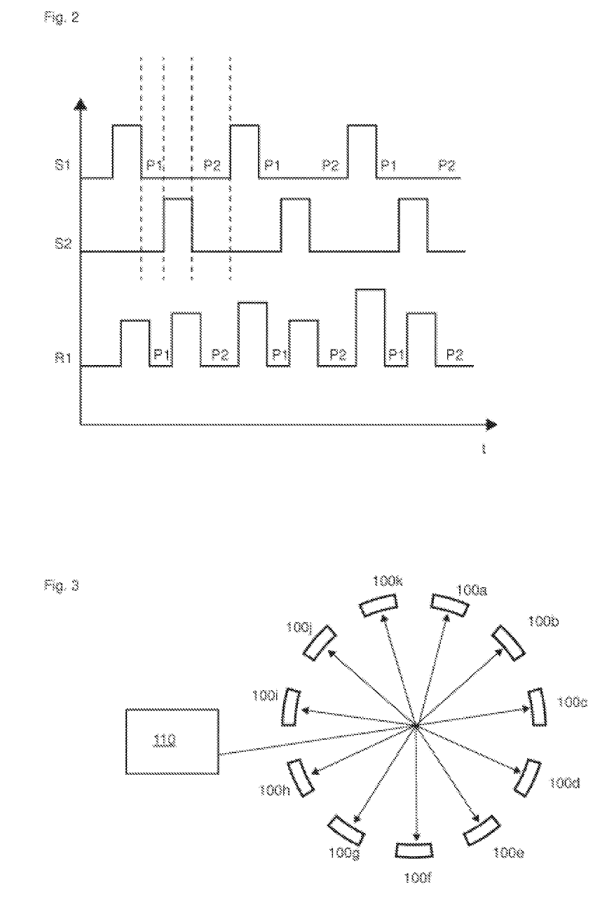

FIG. 2 schematically shows the pulse sequence of two transmitting antennas having equal frequency and the received responses;

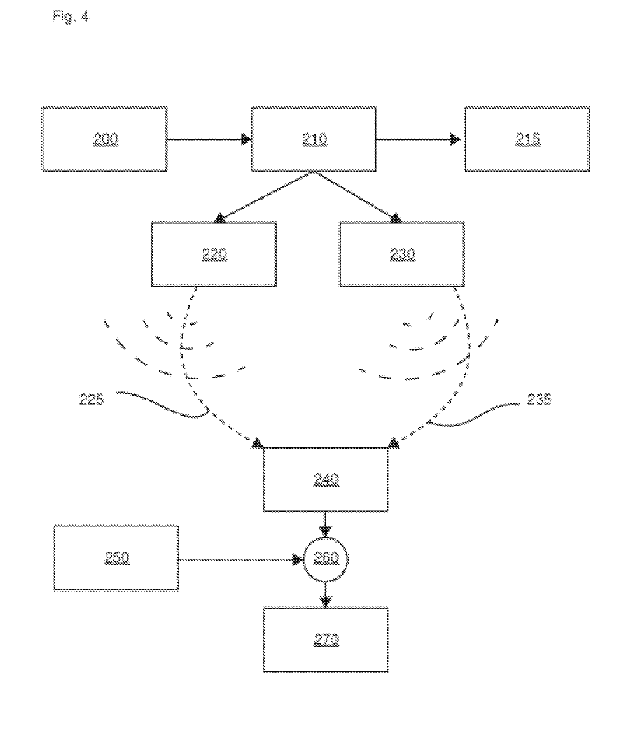

FIG. 3 shows an exemplary embodiment of the invention to simulate a rotating radar antenna;

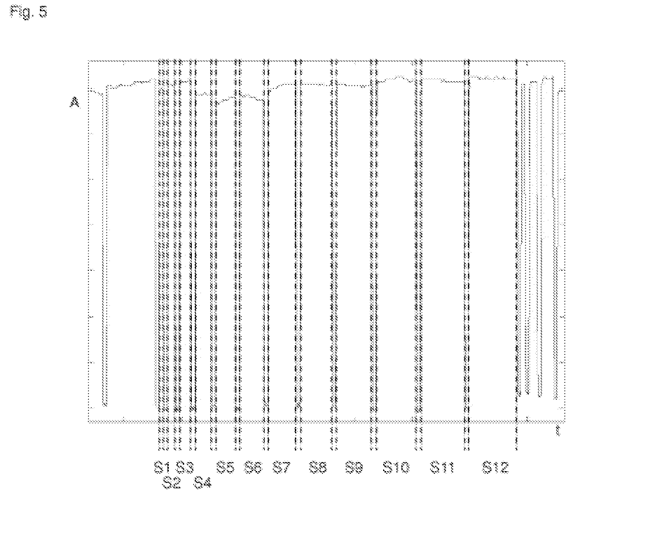

FIG. 4 shows a scheme of a measuring structure to execute the method according to the invention;

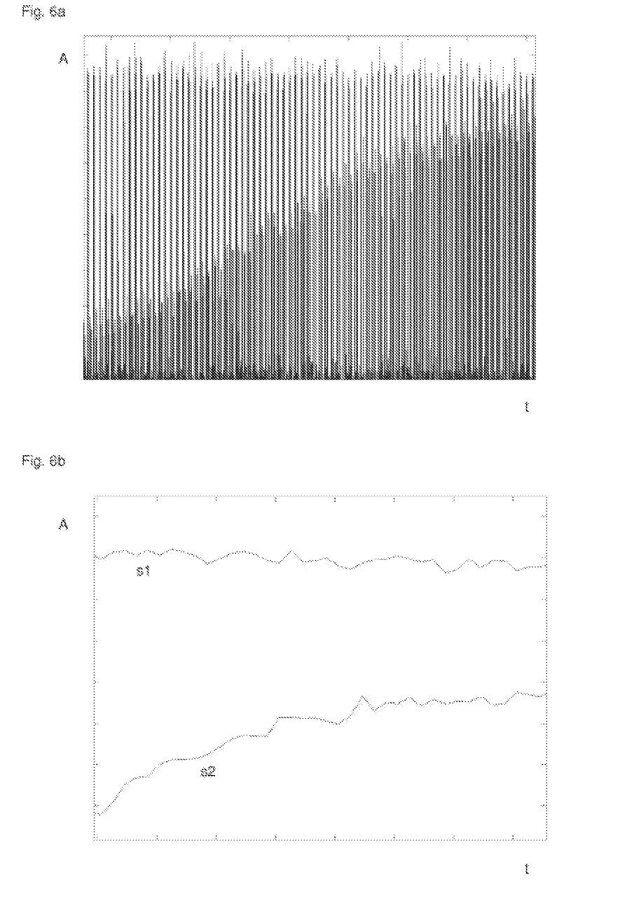

FIG. 5 shows measurement data detected according to the invention of an arrangement having the fundamental construction from FIG. 3;

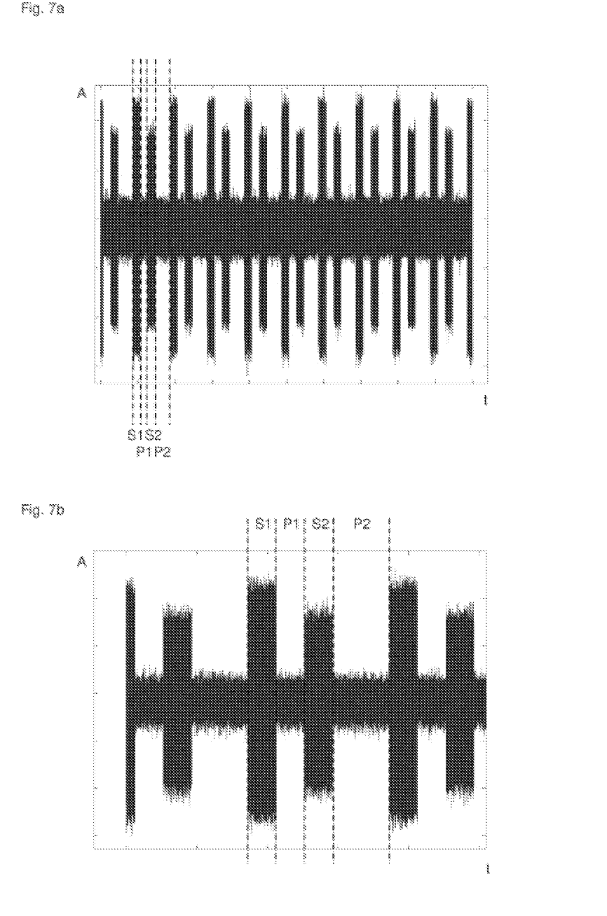

FIGS. 6a and 6b show further measurement data detected according to the invention and signal curves derived therefrom;

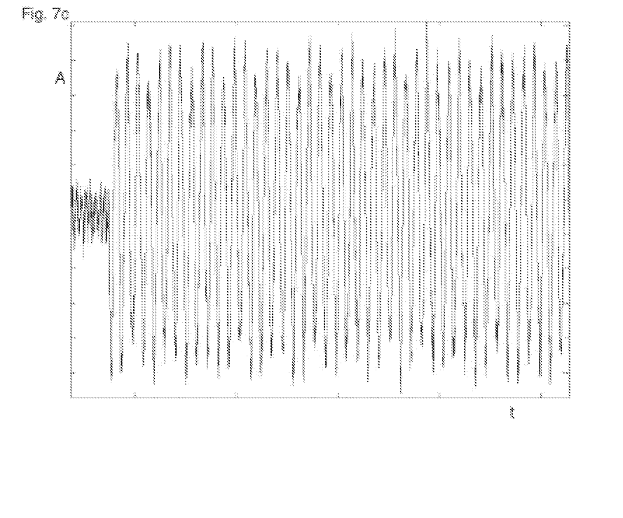

FIGS. 7a to 7c show further measurement data detected according to the invention and signal curves derived therefrom;

FIG. 1 shows a situation at an airport, which is representative for the application of the method according to the invention.

An airplane 10 is located in the landing approach on a runway 11. A navigation system (for example, ILS or rotating radio beacon VOR) 12 emits navigation signals, for example, 15, 16 in various spatial directions, possibly at various points in time. The airplane 10 receives the signals 15 and 16 and can obtain an item of navigation information by way of instruments located on board. For an error-free analysis, however, a substantially uncorrupted reception along a direct propagation path 20 is necessary. Objects in the airport region, for example, an airplane 30 on a taxiway or an adjacent wind power plant 35, serve as interfering objects and scatter signals to the airplane 10 on scattered propagation paths 21 and 22. The original intended item of navigation information can thus be corrupted.

According to the invention, for the analysis of this system, a representative transmitting unit is assigned to each of the navigation signal components 15 and 16. If the studied environment is scaled in its size, in particular shrunken, these units thus transmit to scale at significantly higher frequencies than in the real environment. The representative transmitting units transmit the signals in the various spatial directions, as shown in FIG. 1. The representative transmitters are operated at identical frequency, wherein, however, a chronological feed scheme is maintained to maintain characteristic pause times before and after the signals. The signals received at a possibly chronologically variable study location (for example, location of the airplane 10 during a landing approach) are detected in a broadband and time-resolved manner. Since the signals can be assigned to the antennas on the basis of the pause times, a differentiation on the basis of other features is not necessary, therefore the representative transmitters can also be operated at the same frequency.

FIG. 2 schematically shows a sequence of signal curves of two transmitting antennas S1 and S2. The transmitting antenna S1 is activated to emit high-frequency signals, in this example at 15.9 GHz. The antenna is fed to emit a power profile for a transmitting duration and subsequently to maintain a transmitting pause.

In this example, the representative transmitters are waveguide transmitters, as are described in the above-mentioned dissertation, for example. For example, slotted waveguides are suitable to emit the radiation in matching diagram form.

An essentially identically implemented antenna S2 also emits radiation in another spatial direction for a transmitting duration and maintains transmitting pauses between the radiation phases.

The activation of the antennas can be performed via multiple signal generators or also with the aid of a single signal generator and high-frequency switches.

It is recognizable in FIG. 2 that the times at which one of the antennas emits does not overlap in this example with times at which the other antenna emits. Therefore, pause times are implemented between the respective transmitting phases, which are provided in FIG. 2 with the identifiers P1 and P2. P1 is the pause duration which extends from the end of a transmitting phase of the antenna S1 up to the beginning of a transmitting phase of the antenna S2. P2 is the pause duration which extends from the end of the transmitting phase of the antenna S2 up to the beginning of the transmitting phase of the antenna S1.

It is apparent that the pause durations P1 and P2 are different and in this manner a transmitting phase is identifiable by the pause duration lying before and/or after it. The signal received on the part of the receiver R1 is schematically shown in the lower section of FIG. 2. As a result of different interactions of the emission from the different antennas, the received signal (amplitude) of the different antennas will not be identical even at equal transmitting power. In addition, chronologically variable interactions can occur in the system, so that an amplitude curve shown for receiver R1 may be detected.

Although the amplitude strength does not permit inferences about the emitting antenna, since the emitting antennas both emit at identical frequency, the identification of the emitting antenna is possible on the basis of the detected pause durations in the time curve. The following signal or the preceding signal can be assigned to one of the antennas by the sequence of the pauses or also the measurement of a single pause length. It is possible that due to interactions in the system or signal runtimes, the detected amplitude durations do not completely overlap with the transmitting durations of the antennas. An assignment precision can therefore be increased in that multiple successive pause sequences are analyzed and the interposed pulses are identified on the basis of these multiple pause durations. Even if individual signals or a sequence of signals are entirely lost in the noise of the detection unit due to interaction effects in the system, the assignment is then to be recorded again at any time, as soon as identifiable amplitude values are detected again.

In FIG. 1, for example, the antennas can be set up at the same location, but can be oriented in different spatial directions with their emission direction.

FIG. 3 shows an alternative arrangement of the antennas with associated switching concept. The antennas 100a, 100b, . . . , 100k are arranged along a circular path at equidistant intervals, so that their emission direction is oriented radially outward. These antennas can be successively activated to transmit using an HF switching matrix 110, wherein a cyclic revolution of the activation is achieved. In this manner, by way of the eleven antennas shown as an example, for example, which can also be slotted waveguides here, a radar system is reconstructed as a rotatable antenna. This has the advantage that every known rotational direction of the original system is assigned an antenna in the scaled system. This antenna is respectively identifiable again in the received signals, in that the pause durations between the received signals are analyzed. It is also possible in this example to analyze multiple pause durations, to draw inferences about the origin of the detected signal. A similar embodiment would also be selected, for example, to simulate the individual antenna of the rotating radio beacon at an airport, to thus measure propagation properties in various spatial directions and subsequently be able to join them back into the original navigation signal, which can possibly be corrupted.

FIG. 4 shows a measuring construction, as is usable for the execution of the method according to the invention, in the form of a block diagram.

An oscillator 200 delivers an excitation frequency, for example, a frequency of 16 GHz here. The signal from the oscillator 200 is fed into an HF switch 210, which alternately feeds the antennas 220 and 230, which are implemented as waveguides, according to the invention according to a predefined time scheme. To implement the pause times, i.e., the times at which no antenna 220 and 230 is fed, it is advisable to have the HF switch switched to a non-emitting 50 ohm terminus 215, so that the oscillator can be operated in the continuous CW mode and does not have to be switched itself. The signal durations and pause times provided according to the invention are maintained in this case, which are assigned to every transmitting unit.

From the antennas 220 and 230, the signals arrive on different propagation paths 225 or 235, respectively, through the measuring environment at a receiving antenna 240. Since the signals of the antennas 220 and 230 are fed from the same source (the oscillator 230), initially no assignment to the source is possible on the basis of the received signals.

With the aid of a mixer 260 and a further oscillator source 250, the signal is mixed down to an intermediate frequency. For example, the oscillator 250 feeds a frequency which is decreased by 100 kHz in relation to the frequency of the oscillator 200 into the mixer, so that the intermediate frequency is 100 kHz.

With the aid of an analysis unit 270, the mixed-down signal is analyzed. The time scheme of the feed is used to assign the received signals or the measured chronological amplitude curve to the transmitting units 220 and 230.

FIG. 5 shows a real measurement curve, which was measured using an arrangement similar to FIG. 3. Twelve transmitting antenna, which were activated offset in time, were arranged along a circular line to simulate a rotating radio beacon/radar. Each of the transmitting antennas is excited to transmit for a characteristic duration. The detection is performed in this example using a spectrum analyzer in the zero span operation. FIG. 5 shows the chronological amplitude strength, as detected by the receiving antenna and after mixing to an intermediate frequency.

It is recognizable that signal durations S1, S2, . . . , S12 can be clearly differentiated. Since it is known on the transmitter side which of the representative transmitting units was operated using which transmitting duration, rapid and time-resolved detection is possible and nonetheless the source information is obtained. In this example, each of the antennas has been activated using a different transmitting duration (differences of 10 ms, for example), but the pause times between the activations remain identical.

On the basis of the data, it is possible to determine the amplitude of each representative transmitting unit at the receiving location, wherein each representative transmitting unit corresponds to an angular position of the radar or an activation point in time of the rotating radio beacon.

FIG. 6a shows a real measurement in an alternative measuring environment. This measurement shows that a separate amplitude curve according to FIG. 6b is to be derived from a chronologically-resolved amplitude sequence using two transmitting antennas S1 and S2 by subsequent assignment on the basis of the time scheme. It is recognizable that this measurement method permits a time-resolved measurement of multiple signal sources with low measurement expenditure and in this way also permits time-dependent analyses.

In particular, the functionality of a robust mathematical algorithm can already be shown here, which automatically assigns, from the received chronological amplitude curve 6a, the relevant individual signals to the representative transmitting units and extracts their amplitudes s1 and s2, which individually vary on a propagation path.

FIG. 7a shows a refinement of the invention on the basis of further real measurement data.

FIG. 7a shows a measurement curve detected with high chronological resolution. In contrast to the preceding measurements, the detection occurs here with a storage oscilloscope. This type of analysis also permits a specific item of frequency information to be analyzed. This may initially appear contradictory, since all transmitting units are essentially operated at the same frequency. However, the frequencies can be slightly changed as a function of the signal path, in particular by Doppler shifts.

While the envelope of the curve already permits a classification in the time scheme and therefore an assignment to the transmitters, the items of frequency information offer additional suggestions. In this example, the feed of two representative transmitting units occurred at the same transmitting duration of 20 ms, however, characteristic trailer pause durations were assigned to each antenna, namely 20 ms or 40 ms, respectively.

The envelope of the measurement data is decomposed in a simple manner into signal sections (S1, S2) and pause times (P1, P2). The associated representative transmitting units can be identified on the basis of these signal durations and pause durations. FIG. 7b shows a partial enlargement from FIG. 7a in this case.

FIG. 7c in turn shows a partial detail from FIG. 7b and it is clear that items of information about possible Doppler shifts can additionally also be ascertained. For this purpose, the signal packets (for example, S1 or S2) are subjected to a Fourier analysis. The item of information thus obtained about a Doppler shift can in turn be assigned on the basis of the assignment of the transmitting source according to the invention, which was already performed.

The invention is accordingly suitable, by targeted specification of pause durations between the emission of signals of different antennas or on the basis of the chronological characteristic feed of these antennas for characteristic transmitting durations, for identifying the antennas in the received signal on the basis of these pause durations or transmitting durations and assigning the signals to the antennas or spatial directions, which is a decisive feature for studying multipath propagations in particular in the scaled simulation of navigation systems. Although reference was made to ILS in the above description, the invention can also be applied in the scope of skill in the art to other navigation systems.

1. A measuring method for analyzing the propagation of electromagnetic navigation signals,
wherein at least one representative transmitting unit is assigned to each of the navigation signals,
wherein an analysis unit is coupled to a receiving unit and carries out an amplitude detection at a first frequency, characterized in that the representative transmitting units are at least intermittently operated offset in time,
wherein every representative transmitting unit is assigned a characteristic transmission-free leader pause duration and/or transmission-free trailer pause duration for each of its assigned navigation signals, which is respectively maintained between operating phases of the representative transmitting units,
wherein the analysis unit carries out a time-dependent amplitude detection,
wherein a time curve of received amplitude values is analyzed by the analysis unit to assign the representative transmitting unit and the assigned navigation signal to timeslots of the received amplitude values, in that the pause durations in the time curve of the amplitude values are assigned to the leader pause durations and/or trailer pause durations of the representative transmitting unit.

2. A measuring method for analyzing the propagation of electromagnetic navigation signals,
wherein at least one representative transmitting unit is assigned to each of the navigation signals,
wherein an analysis unit is coupled to a receiving unit and carries out an amplitude detection at a first frequency, characterized in that the representative transmitting units are at least intermittently operated offset in time,
wherein each representative transmitting unit is assigned a characteristic transmitting duration for each of its assigned navigation signals, which is respectively maintained in operating phases of the representative transmitting units,
wherein the analysis unit carries out a time-dependent amplitude detection,
wherein a time curve of received amplitude values is analyzed by the analysis unit to assign the representative transmitting unit and the assigned navigation signal to timeslots of the received amplitude values, in that the durations of the received signals in the time curve of amplitude values are assigned to the transmitting durations of the representative transmitting unit.

3. The measuring method according to claim 1, wherein the propagation of the electromagnetic navigation signals is analyzed with the aid of the representative transmitting units in scaled measuring environments, wherein the scaled measuring environments are shrunken in relation to the original environments to be analyzed, and
wherein the representative transmitting units assigned to the navigation signals are operated using scaled, higher frequencies.

4. The method according to claim 1, wherein, for the amplitude detection, received signals around the first frequency are first converted to a lower intermediate frequency before the amplitude analysis is performed.

5. The method according to claim 1, wherein the representative transmitting units are operated using an identical first frequency.

6. The method according to claim 1, wherein the representative transmitting units are operated at various frequencies, which lie within the bandwidth of the amplitude detection.

7. The method according to claim 1, wherein at least one representative transmitting unit is fed using various chronological feed schemes, wherein the coupling of the feed is performed in a different manner for each of the feed schemes.

8. The method according to claim 1, wherein a plurality of representative transmitting units along a variable emission front is assigned to at least one navigation signal, to simulate a position change or movement of the navigation signals.

9. The method according to claim 1, wherein at least two of the representative transmitting units are oriented for emission in different spatial directions.

10. The method according to claim 1, wherein at least two sequential pause durations and/or signal receiving durations in the amplitude values are analyzed by the analysis unit to assign the representative transmitting units to timeslots of the received amplitude values.

11. The method according to claim 1, wherein the representative transmitting units emit signals in the gigahertz range.

12. The method according to claim 1, wherein the amplitude detection occurs in the zero span mode of the analysis unit.

13. The method according to claim 1, wherein either active transmitting durations of the representative transmitting units or pause durations of the representative transmitting units are equal.

14. The method according to claim 1, wherein the chronological activation of the representative transmitting units is performed using HF switches and/or delay lines.

15. The method according to claim 1, wherein the analysis unit is additionally implemented to analyze the frequency of received signals, in particular to detect Doppler shifts on the signal path.

16. The measuring method according to claim 2, wherein the propagation of the electromagnetic navigation signals is analyzed with the aid of the representative transmitting units in scaled measuring environments, wherein the scaled measuring environments are shrunken in relation to the original environments to be analyzed, and
wherein the representative transmitting units assigned to the navigation signals are operated using scaled, higher frequencies.

17. The method according to claim 2, wherein, for the amplitude detection, received signals around the first frequency are first converted to a lower intermediate frequency before the amplitude analysis is performed.

18. The method according to claim 2, wherein the representative transmitting units are operated using an identical first frequency.

19. The method according to claim 2, wherein the representative transmitting units are operated at various frequencies, which lie within the bandwidth of the amplitude detection.

20. The method according to claim 2, wherein at least one representative transmitting unit is fed using various chronological feed schemes, wherein the coupling of the feed is performed in a different manner for each of the feed schemes.

21. The method according to claim 2, wherein a plurality of representative transmitting units along a variable emission front is assigned to at least one navigation signal, to simulate a position change or movement of the navigation signals.

22. The method according to claim 2, wherein at least two of the representative transmitting units are oriented for emission in different spatial directions.

23. The method according to claim 2, wherein at least two sequential pause durations and/or signal receiving durations in the amplitude values are analyzed by the analysis unit to assign the representative transmitting units to timeslots of the received amplitude values.

24. The method according to claim 2, wherein the representative transmitting units emit signals in the gigahertz range.

25. The method according to claim 2, wherein the amplitude detection occurs in the zero span mode of the analysis unit.

26. The method according to claim 2, wherein either active transmitting durations of the representative transmitting units or pause durations of the representative transmitting units are equal.

27. The method according to claim 2, wherein the chronological activation of the representative transmitting units is performed using HF switches and/or delay lines.

28. The method according to claim 2, wherein the analysis unit is additionally implemented to analyze the frequency of received signals, in particular to detect Doppler shifts on the signal path.
